(19) United States
(12) Patent Application Publication
(10) Pub. No.: US 2015/0249364 A1
(43) Pub. Date: Sep. 3, 2015

(54) Natural Gas Furnace Watchdog

(71) Applicants: Jacob Michael Schmidt, Sylvania, OH (US); Charles Riley Fike, Sycamore, OH (US); Anthony Michael Brown, Leipsic, OH (US)

(72) Inventors: Jacob Michael Schmidt, Sylvania, OH (US); Charles Riley Fike, Sycamore, OH (US); Anthony Michael Brown, Leipsic, OH (US)

(21) Appl. No.: 14/615,945

(22) Filed: Feb. 6, 2015

Related U.S. Application Data
(60) Provisional application No. 61/945,849, filed on Feb. 28, 2014.

(51) Int. Cl. H02J 9/06

(52) U.S. Cl. CPC H02J 9/06

(57) ABSTRACT

A back-up power center for a fuel-operated furnace substantially as described and illustrated herein.

### CROSS-REFERENCE TO RELATED APPLICATIONS

This application claims the benefit of U.S. Provisional Application No. 61/945,849, filed Feb. 28, 2014, the disclosure of which is incorporated herein by reference.

### BACKGROUND OF THE INVENTION

The loss of electricity during the winter months can present a frightening situation for a homeowner. Without electricity, a natural gas furnace will not operate to maintain thermostat temperature. This may not only lead to uncomfortable conditions, but may result in the freezing and failure of water pipes. The solution to the problem presented above would be to implement a device such as the Natural Gas Furnace Watchdog (NGFW) system, the structure and operation of which are set forth herein.

### SUMMARY OF THE INVENTION

The Natural Gas Furnace Watchdog system is essentially a back-up power center for a natural gas-fueled furnace. The system monitors voltage readings from the main feed into the furnace and automatically transfers the furnace to back-up power when needed. A microcontroller monitors and controls various outputs and inputs related to the operation of the device. Parameters such as line voltage, thermostat activity, inverter activity, current draw, and other appropriate points can all be monitored. A battery maintainer device is utilized to recharge the batteries once electrical power from the utility has been restored. The device is capable of supplying power to a modern natural gas furnace for an average of two to three days, although the actual time length may vary depending upon various factors including, but not limited to, thermostat setting, outside air temperature, and power draw of furnace. The furnace may, for example, be a high efficiency Lennox furnace manufactured in 2009, although any furnace is considered to be within the scope of this invention. Such a unit draws very little current at high speeds and is capable of varying the speed depending upon the demand. The unit runs an average of fifteen minutes per hour and as a result does not put a constant load on the batteries within the back-up system. The Natural Gas Furnace Watchdog system will provide peace of mind for a homeowner during the winter months.

The loss of electricity can be a scary situation during any time of the year. A failure of the electric utility during the winter months can present a particularly frightening scenario. During a power outage in the winter months, homeowners are sometimes forced to seek refuge in a hotel because of the loss of heat within their homes. The use of the Natural Gas Furnace Watchdog system of this invention will enable a modern natural gas furnace to operate for an average of two and a half to three days following the loss of electricity from the electric utility.

During an electrical power outage, the gas supply to the house is typically unaffected. The electricity is only needed to supply power to the circuit board and blower motor of the gas furnace. With modern furnaces in use today, the power consumption is minimal. This invention can be used to temporarily power a natural gas furnace during a power outage. This will enable the house to maintain a comfortable operating temperature while electric power from the utility is being restored. The system will be a tremendous asset to the general public and society as a whole. Homeowners will now have the option of staying within their homes during a power outage, instead of relocating to a hotel or other temporary refuge. This invention includes the necessary circuitry to detect the presence or loss of utility power and will automatically switch between the NGFW system and the utility as needed. The homeowner will not have to switch the NGFW system on or off. The NGFW system will not only keep the house warm for the extent of the utility outage, but is quiet and makes no noise.

Thus, one objective of this invention is to create an automatic system that will power a modern natural gas furnace during an electrical power outage. This will allow homeowners to have a feasible way to keep their furnace powered and, thus, their houses maintained at a comfortable temperature during an electrical power outage.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a front elevational view of an enclosure for the NGFW system of this invention.

FIG. 2 is a side elevational view of the enclosure for the NGFW system illustrated in FIG. 1.

FIG. 3 is a perspective view of enclosure for the NGFW system illustrated in FIGS. 1 and 2.

FIG. 4 is a front elevational view of an exterior of the enclosure for the NGFW system illustrated in FIGS. 1 through 3.

FIG. 5 is a schematic diagram of an electronic control system for the NGFW system illustrated in FIGS. 1 through 4.

FIG. 6 is a sample system output waveform diagram for the NGFW system illustrated in FIG. 5.

FIG. 7 is a table showing exemplary runtime test results for the NGFW system illustrated in FIGS. 1 through 6.

### DETAILED DESCRIPTION OF THE PREFERRED EMBODIMENT

The primary objective of the NGFW system is to provide heat to a home while the main electrical service/utility is not available. This will be accomplished by providing electrical power to the home's furnace using the NGFW system. With an input on the main controller to sense when the main electrical utility is off, the system will be able to switch automatically to the NGFW system. This will eliminate the need for a homeowner to connect a generator, or to be on the property at all, when the main electrical utility goes out. When the system senses the main electrical utility is not active, the NGFW power feed will become active, allowing the furnace's electrical system and blower to draw its required power from the NGFW device.

Given the thermostat for the heating/cooling system of the house has a stand-alone power system, the furnace will continue to communicate with the thermostat and maintain the temperature entered at the device.

The NGFW system also provides the homeowner with the option of outlets on the enclosure of the system to power additional lights, phone chargers, or any other electrical device having a small electrical demand. This will eliminate the need to charge anything from a car or alternate power source in the event of an electrical outage.

To address the issue of keeping the batteries in the NGFW charged at all times, a battery maintainer is placed within the system. While the electrical utility is off and the battery maintainer cannot be used, the owner will be able to recharge the batteries by using anything that produces a 12 volt direct current source. This will allow the NGFW system to stay active for an approximated one and a half to two days each time the batteries can be recharged.

The NGFW system is also portable. The system is designed to be a plug-and-play type of system, in addition to the main purpose of providing back-up power to a furnace. The unit is designed so that the owner can disconnect two to three plugs from the back-up system and move the unit to a desired location. This allows the owner to have power wherever the unit is placed and gives an alternative option to the standard furnace hook-up.

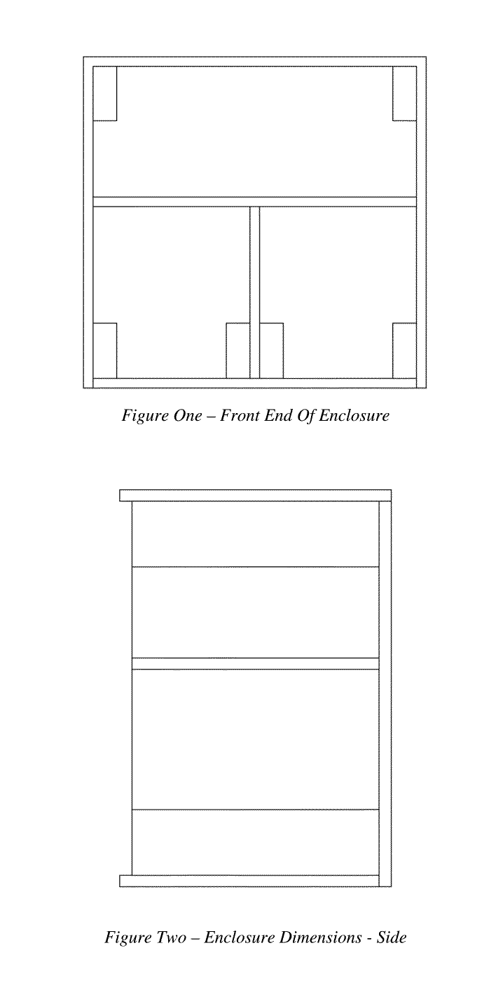

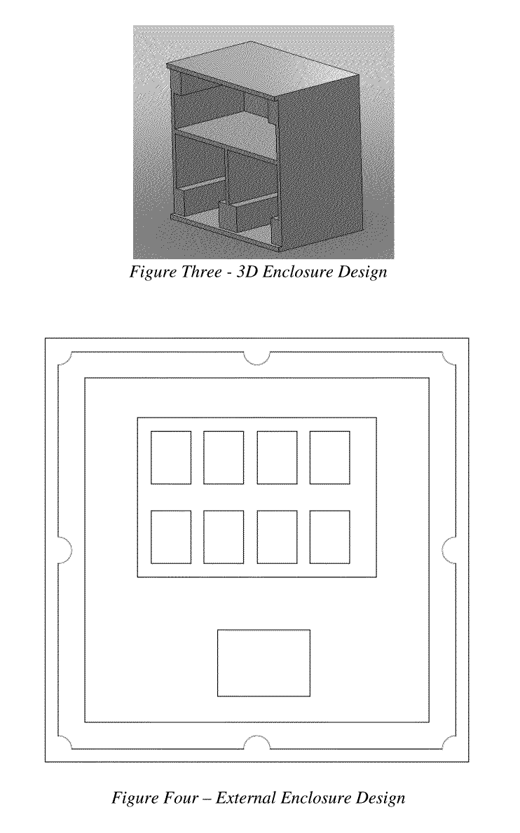

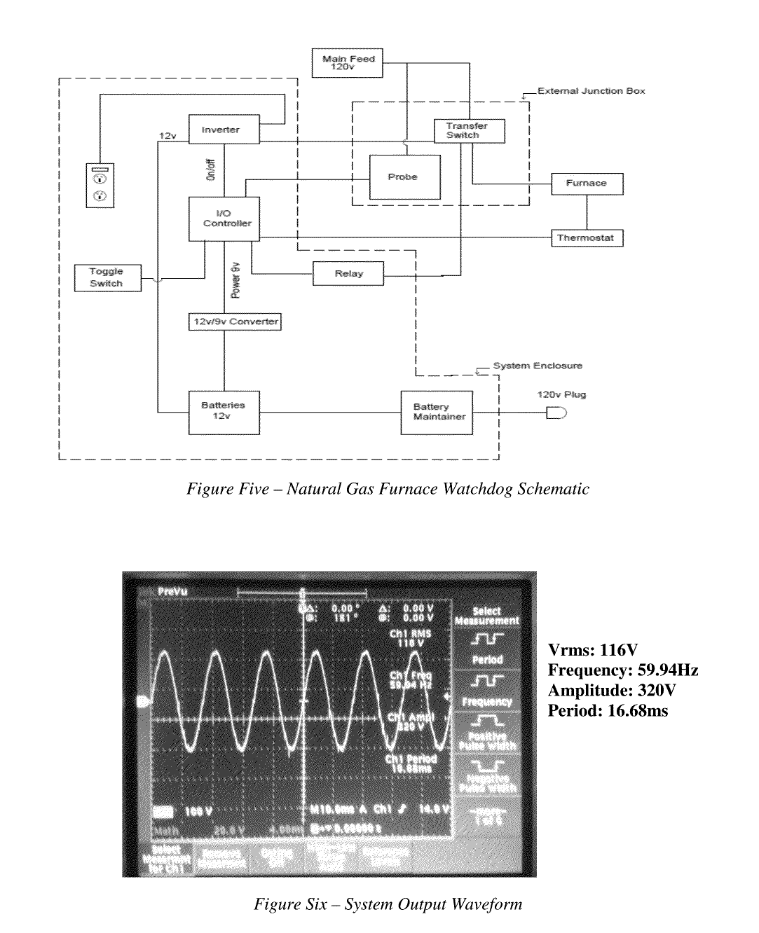

The enclosure that houses the internal components of the NGFW system may be formed from composite materials, although any other suitable material can be used. The enclosure provides stability for the entire device and internal components and is preferably strong enough to support the weight of the internal components, but light enough to easily transport. The illustrated design includes a bottom, a front, two sides, a top, a back, and a vertical/horizontal platform internally, as shown in FIGS. 1 through 3. The physical size of the enclosure is desirably relatively small. The external enclosure (see FIG. 4) is designed to contain a relay board that is responsible for the switching of power between the utility and NGFW system.

The layout of the NGFW system takes into account the desire for a relatively low center of gravity to keep the system stable and functional. The design consists of two 122 amp-hour deep-cycle batteries placed within the bottom two compartments of the enclosure shown above. This design allows for easy access to the batteries in the bottom compartments, as well as provides access to the crucial components of the NGFW system for troubleshooting. A pure sine wave inverter, an Arduino-Uno microcontroller, a battery maintainer, and additional controls equipment can be housed on the second level of the enclosure. The pure sine wave inverter is used to create an alternating current from the direct current source of the batteries. The inverter can be mounted in the very front of the unit on the second level, allowing easy access to the heart of the system. The Arduino-Uno microcontroller can be mounted in the back right corner behind the inverter. The Arduino-Uno microcontroller is responsible for monitoring a utility voltage signal and then, upon a true or false statement from this device, energizing the various components of the back-up system. The battery maintainer can be housed in the back left corner of the enclosure behind the inverter. The battery maintainer's key responsibility is to recharge the batteries when utility is restored, as well as provide a floating voltage on the batteries during periods of non-use. The floating voltage on the batteries ensures they stay fully charged at all times. Thus, when there is a utility failure, the unit can run at peak capacity. To provide the power needed to run the furnace, two deep-cycle batteries are wired in parallel. The inverter is powered by 12V and will be supplied with a 244 amp-hour capacity battery system. Additional batteries may be added for increased runtime. A schematic showing the various connections associated with the system is shown in FIG. 5.

There are various control components that are utilized to ensure the proper operation of the NGFW system. The Arduino-Uno microcontroller functions as the central processing unit of the entire system. A voltage probe is used to sense the presence of electricity from the power utility within a home. The voltage probe functions as the main sensor to determine whether to stop or start the back-up system. If the voltage probe senses a loss of power, the microcontroller will initiate the logic required to energize respective relays for back-up power use. Once electric power from the utility is restored, the voltage probe will communicate with the microcontroller, telling it to switch back to utility. The furnace will be without power for eight seconds upon a failure of utility or during the restoration period of the utility service. The furnace can communicate with the microcontroller via a nine conductor cable that connects the thermostat to the Arduino-Uno microcontroller via an external junction box. When the thermostat sends a call to run signal to the furnace, the Arduino-Uno will be sensing the same signal as well. The presence of the thermostat signal will allow the microcontroller to de-energize the back-up system each time the thermostat removes a call for heat. The NGFW system will remove the source of power from the furnace under this condition, preferably only after a one minute cool down period to allow the system fan to run. The actual switching of power and signals related to the operation of the system will be done by two relay boards. One relay board will be housed in an external box, which will be attached to a wall near the furnace within a home. That box will be responsible for the switching of power between the back-up system and the utility for the furnace. It may be important for furnace operation and should be designed with fail safe capabilities in mind. The second relay board will be housed within the NGFW system itself. That relay board will be responsible for the energizing and de-energizing of the inverter and battery connections.

The software for this system may be programmed using the C language or any other conventional programming language. The pins of the Arduino-Uno microcontroller may be initialized for the various inputs and outputs. The outputs consist of the inverter signal, V_{cc} for relay boards, and the transfer switch. The inputs consist of the thermostat signal and toggle switch status. A loop routine can be used to observe the status of the thermostat and voltage probe. If the toggle switch were to become active, all other aspects of the program will be ignored. If the toggle switch is not active, the loop will proceed to checking the thermostat signal and voltage probe signal. The inverter will only become energized if the voltage probe senses a loss of utility and the thermostat calls for the unit to run. The program then initiates the relay board after a delay, which operates as a transfer switch. This switches the power to the furnace from utility to back-up power. When the thermostat no longer provides a call-for-heat signal, the system will enter a cool down state. Once this state has subsided, the inverter will shut off to save power. The process will then repeat itself upon the next call for heat from the thermostat. The voltage sensor will always continue to look for the restoration of utility during the entire process.

The NGFW system may, if desired, constantly read a signal from the homeowner's utility connection via a voltage sensor. The Arduino-Uno microcontroller then analyzes that signal to ensure the utility is still active. If the utility becomes inactive, the microcontroller will initiate a transfer of power between the furnace's utility connection and back-up power. A delay will take place from recognition of utility failure to switching of power from the main feed to the NGFW system. This will allow for a ‘reboot’ condition of the furnace if it happens to be running at the time of the utility failure. That way the system ensures that arcing and an impulse does not occur from the transferring of power sources.

Once the NGFW system becomes energized, the Arduino-Uno microcontroller will look for a signal from the homeowner's thermostat. If the thermostat calls for heat then the microcontroller will keep the inverter operational. If the thermostat does not call for heat, the microcontroller will shut the system down to conserve energy. The microcontroller, however, will remain active to sense the presence of the utility connection and the state of the thermostat.

Upon recognition of the utility being restored, the microcontroller will allow for an eight second delay to switch the furnace from the NGFW system to utility. Once the utility is restored, the battery maintainer will begin re-charging the two deep-cycle batteries. The inverter system will shut down, but the microcontroller will remain active to sense a future utility failure. A toggle switch is placed on the outside of the unit to enable the inverter directly. This design will allow the unit to be used as a recreational power source if desired.

Having the system of this invention installed in a home will offer a tremendous amount of security when the power goes out in the winter. When it is unclear how long the power will be out, this system will be able to heat the home for an extended period of time. Homeowners will not have to worry about their pipes freezing or having to move to a hotel for the period of time that the power is out. Added up over time, the installation of the NGFW system will not only save a household money, but will offer tremendous peace of mind. No longer will the general public have to be solely dependent upon the electric grid during the winter season.

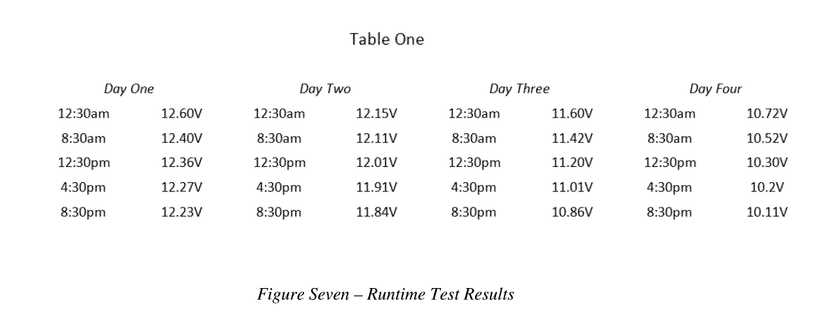

Sample runtime results for the NGFW system are illustrated in FIG. 7. As shown therein, the NGFW system powered a 2009 Lennox furnace for roughly 92 hours. That furnace has a 95% efficiency rating and is capable of outputting 85,000 BTUs. FIG. 6 is representative of the output waveform for the back-up power system. The values displayed to the right of FIG. 6 are very close to the utility power coming in and are therefore suitable conditions to power the ‘test’ furnace. FIG. 7 outlines the exact voltages and runtimes of the system over a four day period.

The results displayed above outline and demonstrate the effectiveness of the system and its potential benefits to society. The days of being totally without heat during a power outage in the winter may soon become a thing of the past. The furnace used to test the system is an average sized furnace for a residential home. The NGFW system is capable of powering a modern natural gas-fueled furnace for two and a half to three days. In general, two to three days is the average duration of a power outage after an event such as a winter storm. There are, however, periods in which the electric utility could be out for more than three days. In this case, a homeowner has the ability to recharge the batteries from a nearby power source or portable gas generator. The unit will take an average of six hours to charge. Upon completion of an additional charging cycle, the system will run for another two to three days depending upon the outside temperature.

In closing, the NGFW system could be a tremendous asset to a homeowner by providing a cost-effective way to back up the arguably most important appliance in a house. The days of worrying about freezing pipes and freezing indoor temperatures, during a utility failure, will be drastically diminished. The design will revolutionize the way people respond to emergency power outage situations.

Although this invention has been described and illustrated in the context of a furnace that uses natural gas as a fuel, it will be appreciated that this invention may be practiced in connection with furnaces that use other fuels such as, for example, propane, liquefied petroleum gas, fuel oils, and the like.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A back-up power center for a fuel-operated furnace substantially as described and illustrated herein.
